(19) United States
(12) Patent Application Publication
(10) Pub. No.: US 2016/0098945 A1
(43) Pub. Date: Apr. 7, 2016

(54) MAGNETIC PRINT ART

(71) Applicant: ART.COM, INC., Emeryville, CA (US)

(72) Inventor: Gary Takemoto, Oakland, CA (US)

(21) Appl. No.: 14/873,888

(22) Filed: Oct. 2, 2015

Related U.S. Application Data
(60) Provisional application No. 62/060,306, filed on Oct. 6, 2014.

(51) Int. Cl. G09F 7/12; B44C 3/00; A47G 1/06

(52) U.S. Cl. CPC G09F 7/12; A47G 1/0638; B44C 3/00; A47G 2001/0666; A47G 2001/0672

(57) ABSTRACT

Disclosed here are methods, systems, paradigms and apparatus for displaying artworks using magnetic prints and magnetic frames. A magnetic print is an artwork printed on a flexible sheet that can be magnetically attached to a magnetic frame, which has magnetic properties. The flexible sheet is made using one or materials, including a metal that is attracted to a magnet. The flexible sheet can also contain a magnet, which is attracted to the magnetic frame. The flexible sheet has an artwork on one surface and can be removably attached, e.g., magnetically, to the magnetic frame on a second surface. The magnetic frame and print facilitates easy switching of the artwork. For example, when a user wishes to switch an existing artwork to a new artwork, the user can peel off the old magnetic print from the magnetic frame and lay out the new magnetic print on the magnetic frame.

### CROSS-REFERENCE TO RELATED APPLICATION(S)

This application claims the benefit of U.S. Provisional Application Ser. No. 62/060,306 titled “Magnetic Print Art” filed Oct. 6, 2014, which is incorporated herein by reference for all purposes in its entirety.

### TECHNICAL FIELD

The technology relates to picture frames and artworks, and more specifically to magnetic print artworks.

### BACKGROUND

It is common practice for people to hang items such as pictures, paintings or any artworks on walls. Typically, a picture is inserted into a picture frame and the picture frame is mounted on the wall. When they want to change the picture to a new picture, they typically buy another picture frame, install the new picture into the other picture frame and replace the old picture frame on the wall with the new picture frame. In some cases, the existing the picture frame can be reused to display the new picture; the picture in the existing picture frame can be replaced with the new picture, provided the dimensions of the new picture is compatible with the picture frame, and the picture frame can be mounted back on the wall.

There are some disadvantages with the above methods for displaying a picture and/or switching the pictures. For example, to switch a picture by reusing the existing picture frame, a person may have to dismount the picture frame from the wall, open the back of the picture frame to remove the existing picture and install a new one, lock the back portion safely and mount the picture frame back on the wall. A person has to perform these steps while ensuring the glass portion of the picture frame does not fall off from the picture frame, the person does not get his fingerprints on the glass, and/or manages to switch to the new picture without accidentally damaging the picture, e.g., tearing the picture or folding the picture and therefore, creating a crease. Not only this method is very tedious and cumbersome, it can also have the potential to damage the picture. The person may alternatively replace the picture frame with a new picture frame, that is, install the new picture into the picture frame and replace the existing picture frame with the new picture. This approach still has some of the problems that are associated with the earlier method—the new picture has to be still installed in the new picture frame, the method of which, as described earlier, has the potential to cause an accidental damage to the picture being installed. Further, buying another picture frame costs money and many not be viable every time the picture is to be switched, especially if the person's taste towards the artworks change too often. Also, if the new picture frames mounting mechanism is not compatible with the old picture frame's mounting mechanism, new mounting hardware may have to be bought and new holes may have to be drilled in the wall, which can all be cumbersome, inconvenient and not preferable.

### BRIEF DESCRIPTION OF THE DRAWINGS

One or more embodiments of the disclosed techniques are illustrated by way of example and not limitation in the figures of the accompanying drawings, in which like references indicate similar elements.

FIG. 1A is an example of a magnetic frame that can be used to display a magnetic print, consistent with various embodiments.

FIG. 1B shows a number of examples of the magnetic frame of FIG. 1A.

FIG. 2 is an example of a magnetic print, consistent with various embodiments.

FIG. 3 is an example of laying out a magnetic print of FIG. 2 on a magnetic frame of FIG. 1A, consistent with various embodiments.

FIG. 4A is an example of a magnetic print laid out on the magnetic frame of FIG. 1

FIG. 4B is another example of a magnetic print laid out on the magnetic frame of FIG. 1.

FIG. 4C shows an example in which multiple magnetic prints are laid out on a magnetic frame of FIG. 1, consistent with various embodiments.

FIG. 5A is an example illustrating switching an existing magnetic print installed on the magnetic frame of FIG. 1 to another magnetic print, consistent with various embodiments.

FIG. 5B shows another example for switching an existing magnetic print installed on the magnetic frame of FIG. 1 to another magnetic print, consistent with various embodiments.

FIG. 6 is an environment in which the art application discussed above can be implemented, consistent with various embodiments.

FIG. 7 is an example of a first graphical user interface (GUI) of the art application, consistent with various embodiments.

FIG. 8 is an example of a second GUI of the art application, consistent with various embodiments.

FIG. 9 is an example of a third GUI of the art application, consistent with various embodiments.

FIG. 10 is a block diagram of an apparatus that may perform various operations, and store various information generated and/or used by such operations, consistent with various embodiments.

### DETAILED DESCRIPTION

Disclosed here are methods, systems, paradigms and apparatus for discovering, visualizing and facilitating the installation of magnetic prints. In some embodiments, a magnetic print is an artwork printed on a flexible sheet that can be magnetically attached to a magnetic frame. The flexible sheet is made using one or materials, including a specified amount of a metal that is attracted to a magnet. The flexible sheet has an artwork on one surface and can be removably attached, e.g., magnetically, to the magnetic frame on a second surface. In some embodiments, the technology provides a magnetic print art kit (“kit”), which includes one or more magnetic prints and a magnetic frame that facilitates the display of a magnetic print. The kit allows a user to install a magnetic print and/or switch between magnetic prints conveniently. The magnetic print is installed on the magnetic frame by laying out the flexible sheet on the magnetic frame. An artwork can include a picture, a painting, a poster, an art print, a drawing, an illustration, etc.

The user can install the magnetic frame on a supporting structure, e.g., a wall, using the necessary hardware and tools, and lay the magnetic print on the magnetic frame. In some embodiments, the kit can also include the necessary hardware for installing the magnetic frame. The kit allows the user to switch art, that is, replace the existing art with a new art easily. A new art can be installed by peeling off the existing magnetic print from the magnetic frame and laying the magnetic print of the new art on the magnetic frame. Switching the art is that convenient. The user may not have to bother about buying or installing a new frame for switching the art, instead the user can just focus on buying the new art. This saves time, effort and costs involved in switching the art. Further, unlike with the conventional picture frames, the user may not have to be concerned about breaking the glass of the picture frames while switching the artwork.

In some embodiments, the technology provides various tools for discovering, visualizing and buying the magnetic prints. For example, the technology provides an application (“art application”) using which a user can search, view and/or buy magnetic prints. The art application can be implemented in various configurations, e.g., as a website, a mobile app. Users may access the art application from a variety of computing devices, e.g., a desktop, a laptop, a smartphone, a tablet. The user can search for the magnetic prints based on various criteria, e.g., dimensions of the magnetic print, a genre of the magnetic print, a color, an artist, a finish type. The genre of the magnetic art can be a category of the artwork, such as, contemporary, classic, vintage, modern, eclectic, romantic, traditional, etc. The finish type can include glossy, matte, etc.

The art application supports various methods for obtaining the magnetic prints. For example, the user can buy a magnetic print on an ad hoc basis. In another example, the art application can provide a subscription model where the user can subscribe for buying a specified number of magnetic prints on a regular basis. In yet another example, the art application can provide a subscription model where the user can subscribe for renting magnetic prints. In the renting subscription model, the user can rent a specified number of magnetic prints for a specified period, and at the end of the specified period, new magnetic prints are delivered to the user, which the user can switch to. After switching, the user may return the older prints to the provider. The magnetic prints would be delivered to the user specified address automatically. Further, the art application can be personalized based on user preferences to send magnetic prints that match the user preferences.

In some embodiments, the art application can be adopted by an art merchant who sells the magnetic prints as well as the kits. In some embodiments, the art application can be adopted by a third party service provider who can collaborate with a number of art merchants and facilitate selling of their magnetic prints through the application. In some embodiments, the third party service provider may sell the kits in which case the magnetic prints sold by the art providers may have to be compatible with the kits sold by the third party service provider. For example, the sizes and shapes of the prints have to be compatible with the sizes and the shapes of frames sold by the third party service provider. In some embodiments, the third party service provider can be an interior decorator.

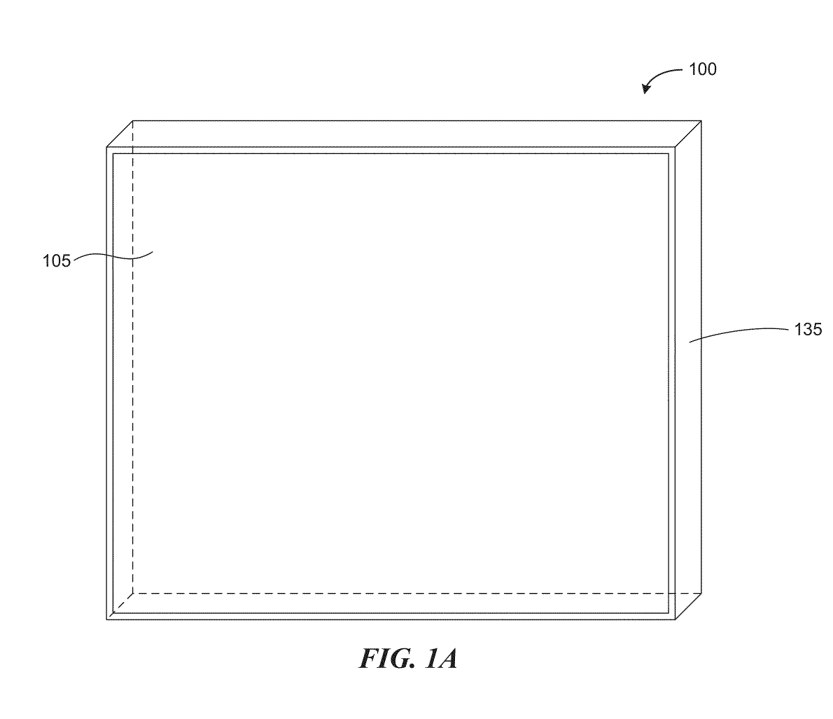

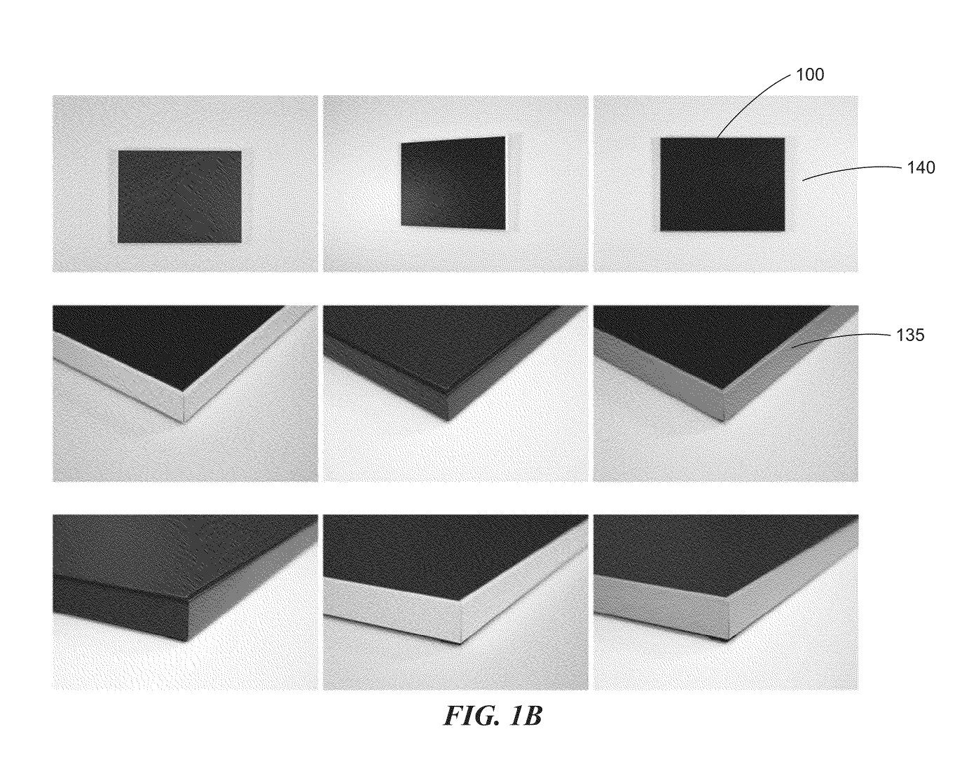

FIG. 1A is an example of a magnetic frame 100 that can be used to display a magnetic print, consistent with various embodiments. The magnetic frame 100 has a planar or a flat surface 105 that has magnetic properties. A magnetic print can be displayed using the magnetic frame 100 by attaching/placing/laying out the magnetic print on the flat surface 105. The magnetic print, which is made of a flexible sheet containing metal, magnetically attaches to the magnetic frame 100 on the flat surface 105. The magnetic frame 100 can be of any shape and size. In some embodiments, the magnetic frame 100 can be of standard sizes and shapes known in the art industry.

FIG. 1B shows a number of examples of the magnetic frame 100 of FIG. 1A. The flat surface 105 can be of various colors. In FIG. 1B, the flat surface 105 is of black color. However, the flat surface 105 can be of any color or can even have an artwork on it, which is displayed in the absence of the magnetic print. When the magnetic print is laid out on the flat surface 105 of the magnetic frame 100, the flat surface 105 is concealed.

The magnetic frame 100 can have different types of borders, e.g., a wooden border, a metal border, a plastic border. The borders, e.g., border 135, can be of different colors, different materials, different patterns, or different shapes. For example, the borders of the magnetic frames in FIG. 1B are of white, grey and black colors.

In the FIG. 1B, the magnetic frame 100 is installed on a supporting structure such as a wall 140. However, the magnetic frame 100 can be installed in various other ways. For example, the magnetic frame 100 can be configured as a stand-alone magnetic frame, that is, the magnetic frame 100 can be supported by a stand-like structure (not shown) or include structure that can used to place it on a flat surface. In another example, the magnetic frame 100 can be placed in a shelf, on a desk, or suspended from a ceiling. In yet another example, the magnetic frame 100 can be part of or integrated with other items, e.g., household items such as a refrigerator door, a wardrobe door. As described above, the magnetic frame 100 can be part of a kit. In some embodiments, the kit can be sold with the necessary hardware for installing the magnetic frame 100 in a variety of ways.

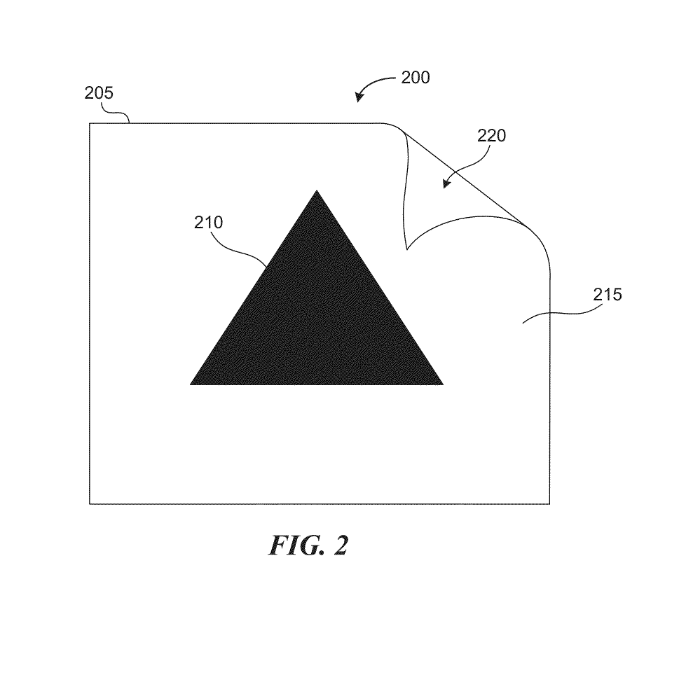

FIG. 2 is an example of a magnetic print 200, consistent with various embodiments. In some embodiments, the magnetic print 200 has an artwork 210 printed on a flexible sheet 205 that is attracted to a magnet, e.g., the flat surface 105 of the magnetic frame 100. The flexible sheet 205 contains a specified amount of metal that facilitates in magnetically attaching the flexible sheet 205 to the flat surface 105. The metal is type of a metal that is attracted to a magnet. The amount of metal and/or other materials used in manufacturing the flexible sheet is chosen such that the flexible sheet 205 is flexible enough to be folded conveniently, e.g., for storage, packaging, carrying and/or shipping and strong enough to be magnetically attached to the magnetic frame 100. In some embodiments, the flexible sheet 205 can be rolled into a tube-like shape, e.g., for easy storage and shipping, and rolled back into flat surface for laying it out on the magnetic frame 100 without causing any creases to the flexible sheet 205.

In some embodiments, the flexible sheet 205 can include a magnet, which is attracted to the magnetic frame 100.

In some embodiments, the artworks are printed on the flexible sheet 205 using printers that support printing on such flexible sheets. In some embodiments, the artwork 210 can also be painted onto the flexible sheet 205. The flexible sheet 205 has the artwork 210 on a first surface 215 of the flexible sheet 205 and is attached to the magnetic frame 100 on a second surface 220 of the flexible sheet 205. The magnetic prints can be available in various sizes. The magnetic print 200 is typically of a size compatible with a magnetic frame, e.g., magnetic frame 100, it is installed on. In some embodiments, the magnetic print can be made according to a user specified dimension.

In some embodiments, the magnetic prints can be installed on magnetic surfaces other than the magnetic frame provided in the kit, e.g., on a refrigerator which has a magnetic surface. The magnetic print 200 can also be printed in custom sizes, e.g., in a size that covers an entire door of a refrigerator.

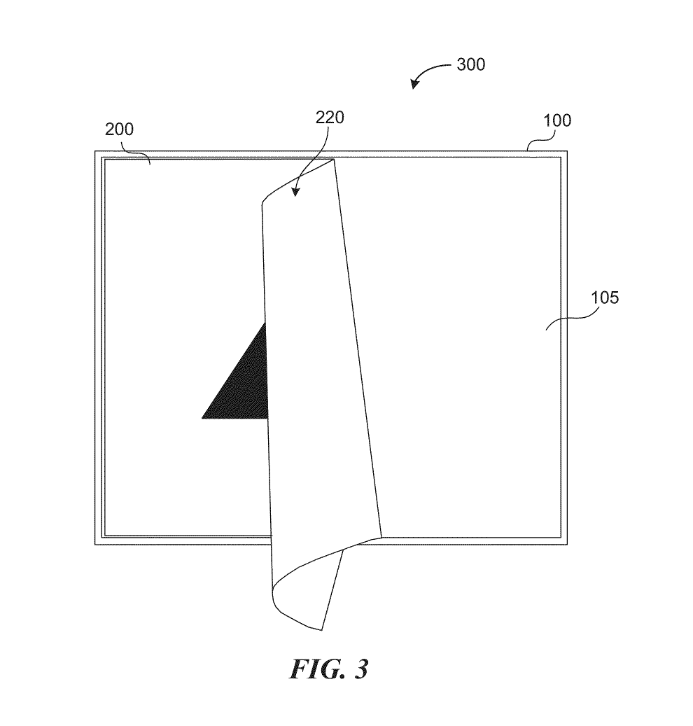

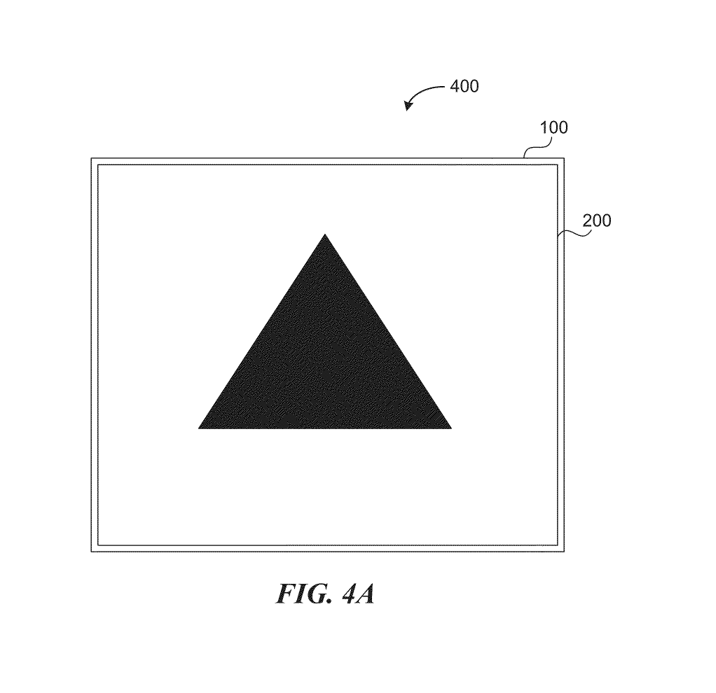

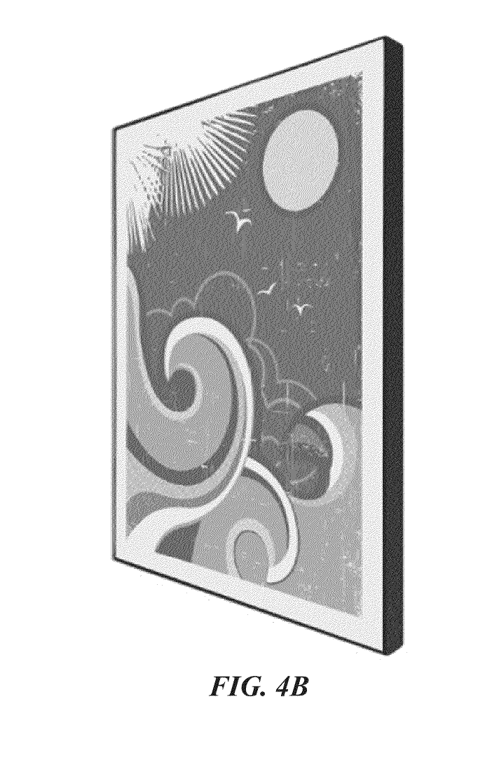

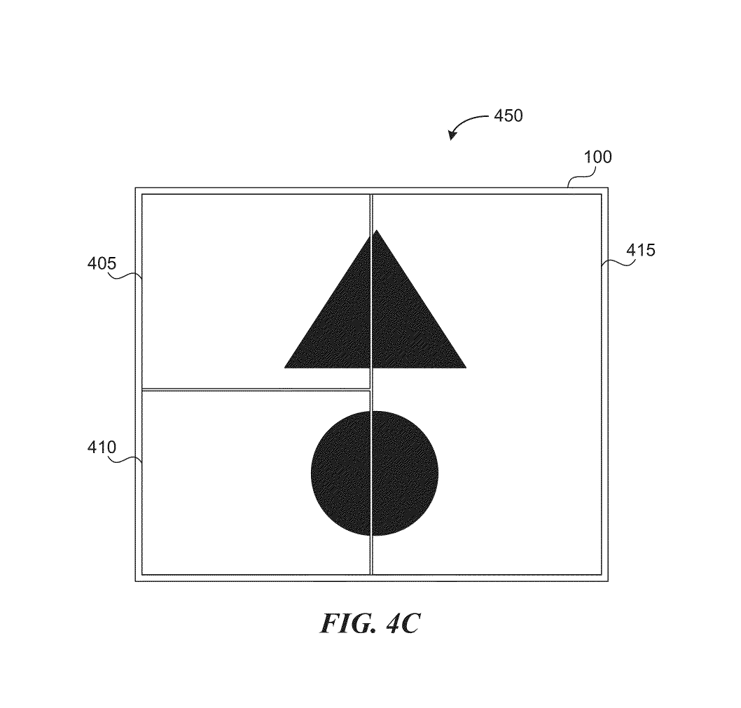

FIG. 3 is an example 300 of laying out a magnetic print 200 of FIG. 2 on a magnetic frame 100 of FIG. 1A, consistent with various embodiments. The magnetic print 200 can be laid out onto the flat surface 105 of the magnetic frame 100 as illustrated in the example 300. For example, the magnetic print 200 can be placed on the flat surface 105 with the second surface 220 of the flexible sheet 205 touching the flat surface and then rolled out onto the flat surface 105. The flat surface 105 magnetically attracts the magnetic print 200 and retains it on the flat surface 105 as illustrated in the example 400 of FIG. 4A. FIG. 4B is another example of a magnetic print laid out on the magnetic frame of FIG. 1.

FIG. 4C shows an example in which multiple magnetic prints are laid out on a magnetic frame of FIG. 1, consistent with various embodiments. In some embodiments, more than one magnetic print can be laid out on the magnetic frame 100, e.g., adjacent to each other. In the example 450, three magnetic prints, e.g., a first magnetic print 405, a second magnetic print 410 and a third magnetic print 415, are laid out on the magnetic frame 100. Further, the magnetic prints can be laid out on the magnetic frame in a certain fashion, e.g., to form a pattern. The magnetic prints can be of different dimensions.

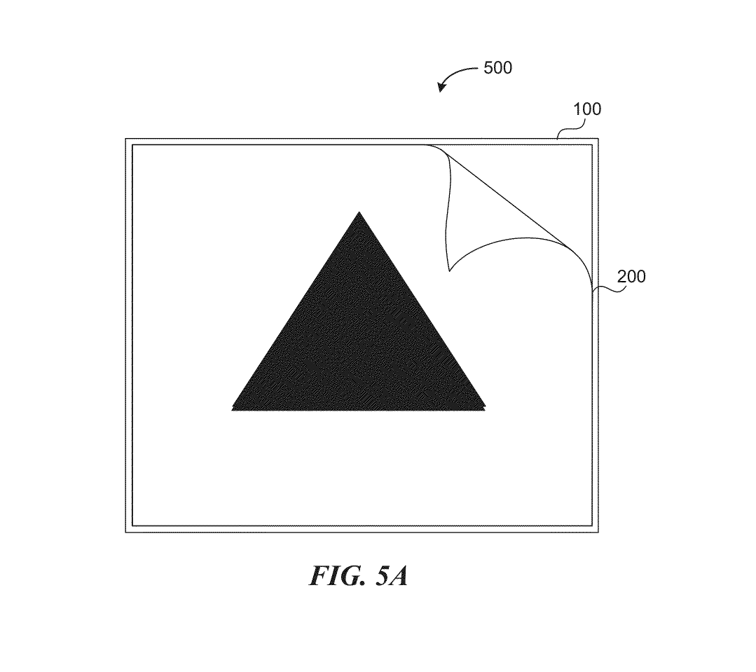

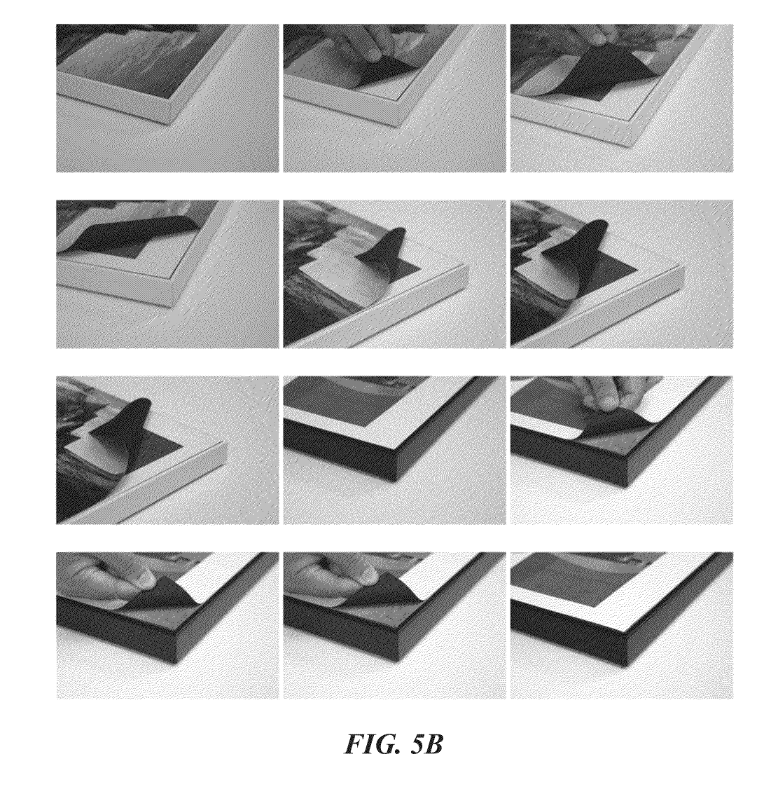

FIG. 5A is an example 500 illustrating switching an existing magnetic print installed on the magnetic frame of FIG. 1 to another magnetic print, consistent with various embodiments. The magnetic print, e.g., magnetic print 200, attached to the magnetic frame 100 can be switched to another magnetic print conveniently. As illustrated in the example 500, the existing magnetic print 200 can be peeled off of the magnetic frame 100, and a new magnetic print (not illustrated) can be laid out on the magnetic frame 100, e.g., as described in the example 300. This way the user can reuse the magnetic frame 100 with the new magnetic print, thereby saving time, effort and costs involved in installing a new magnetic frame and/or eliminate the risk of damaging the artworks as can be the case with conventional picture frames.

In some embodiments, the magnetic print 200 is a single layered flexible sheet. That is, the magnetic print 200 can be attached to the magnetic frame 100 directly without any other backing or supporting structure between the magnetic print 200 and the magnetic frame 100. The magnetic print 200 does not require an additional layer of supporting structure, such as additional metal sheets, between the second surface 220 of the magnetic print 200 and the flat surface 105 of the magnetic frame 100, to attach the magnetic print 200 to the magnetic frame 100.

FIG. 5B shows another example for switching an existing magnetic print installed on the magnetic frame of FIG. 1 to another magnetic print, consistent with various embodiments.

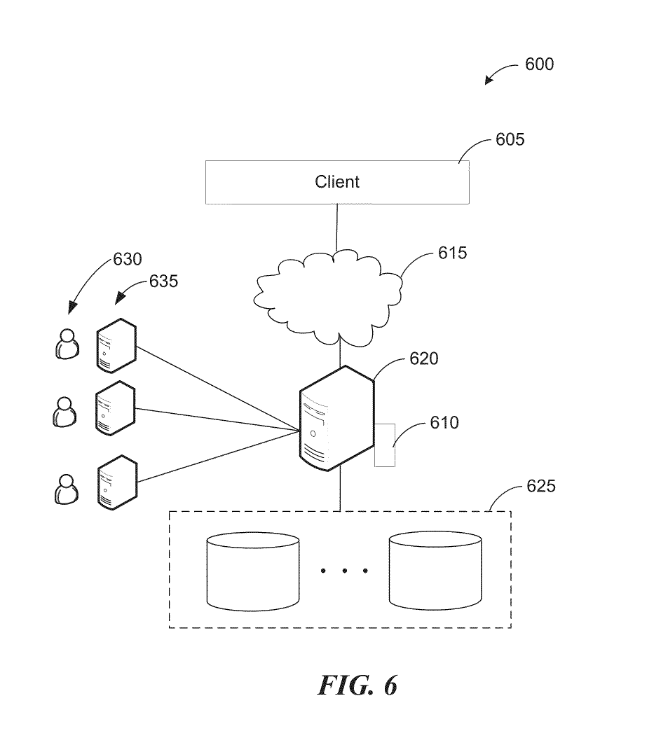

FIG. 6 is an environment in which the art application discussed above can be implemented, consistent with various embodiments. The environment 600 includes a server device 620 on which the art application 610 can be implemented. The art application 610 can be implemented in the environment 600 in a number of ways. For example, the art application 610 can be installed as a software application on the client device 605, e.g., as a mobile app, as a plugin to a web browser on the client device 605. In another embodiment, the art application 610 can be installed as server-client software, where a client part of the art application 610 is installed on the client device 605 and a server part of the art application 610 is installed on the server 620. In yet another example, the art application 610 can be implemented as a server side application only and the client device 605 may access the art application 610 using the web browser on the client device 605. The client device 605 can include a number of devices such as a smartphone, a tablet computer, a laptop, or a desktop.

The environment 600 includes a storage system, e.g., storage system 625, that can store various data, e.g., representations of the magnetic prints (artworks), information regarding the artworks, such as dimensions, genre, etc. The storage system 625 can also include data regarding users, e.g., user profile information of users interested in buying magnetic prints, users interested in subscribing to the services provided by the art application 610, such as the rental and/or subscription service discussed above. The storage system 625 can also include data regarding art merchants 630 who wish to sell their artwork through the art application 610. For example, the art merchants 630 can connect to the art application 610 from their corresponding server devices 635 to communicate with server 620 for selling their artworks through the art application 610. In some embodiments, the art application 610 can include a component (not illustrated), which the art merchants 630 can install on their servers 635, that facilitates selling their artworks via their corresponding websites, apps, etc.

The client device 605 communicates with the server 620 over a communication network 615. The communication network 615 includes wide area network (WAN), local area network (LAN), Internet, or such other similar networks. The connection between the client device 605 and the communication network 615, and between server 620 and the communication network 615 can be wired or wireless.

The art application 610 enables the user to search, visualize, buy and/or rent magnetic prints such as the ones discussed above at least with reference to FIGS. 2-5B. The art application 610 can help the users search for the magnetic prints based on various criteria, e.g., dimensions of the magnetic print, e.g., length and width; dimensions of the magnetic frame, e.g., length, width, thickness; genre of artwork, e.g., abstract, modern, classic; artist name. The art application 610 also provides the art merchants 630 an easy way to profile their artwork based on various metadata of the artwork to enable easy retrieval of artwork during the search.

The users can also visualize how the artwork looks in a setting, e.g., a room. For example, the user can upload a picture of a setting, e.g., the room where the user intends to install the artwork, and the art application 610 can render the user selected artwork in the setting uploaded by the user on the client device 605. The user can get an idea as to how the artwork looks in the setting. In some embodiments, the art application 610 can also render the artwork using a number of sample settings stored at the storage system 625.

The art application 610 facilitates the user to buy the magnetic print kits as well. In some embodiments, a kit includes one or more magnetic frames and one or more magnetic prints. The art application 610 enables the user to buy a kit, a magnetic frame and/or a magnetic print. The user can specify the criteria for the magnetic frame and the art application 610 retrieves the representations of the magnetic frames accordingly. The user can select one or more the retrieved magnetic frames for buying and/or renting.

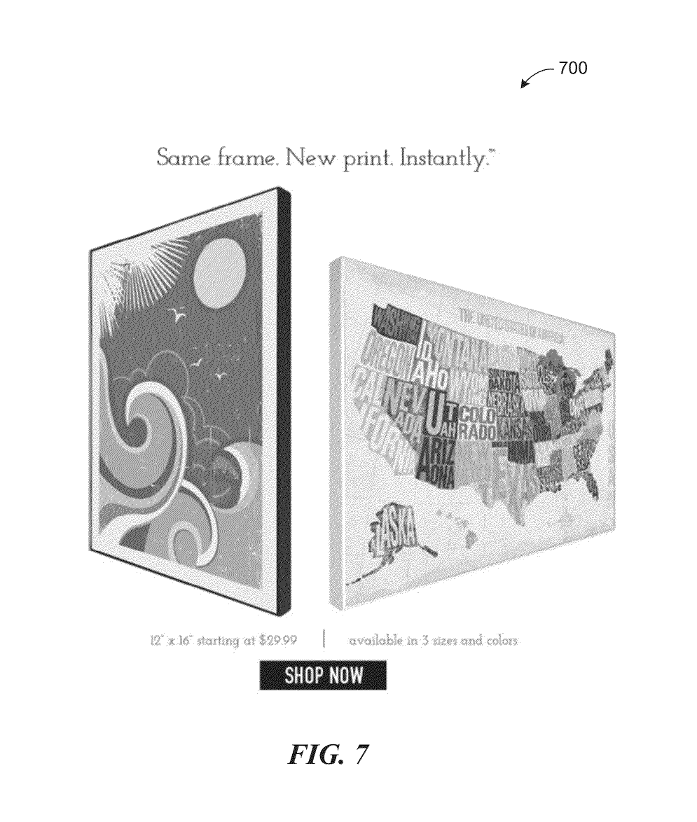

FIG. 7 is an example of a first graphical user interface (GUI) 700 of the art application 610, consistent with various embodiments. The first GUI 700 allows the user to shop for various magnetic frames. The first GUI 700 indicates that the magnetic frames are available in various sizes and colors.

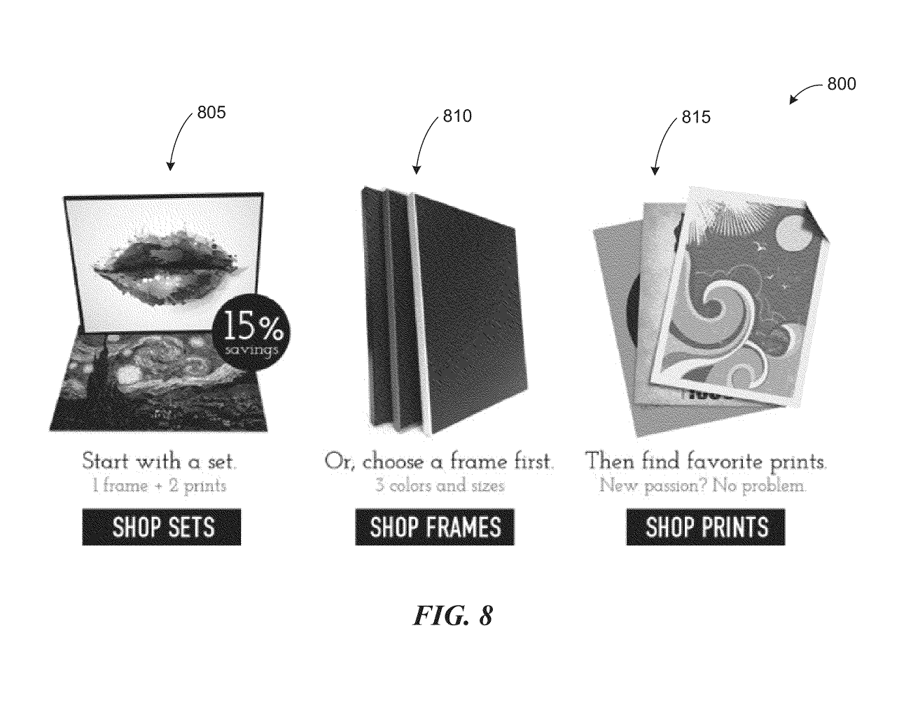

FIG. 8 is an example of a second GUI 800 of the art application 610, consistent with various embodiments. The second GUI 800 allows the user to shop for magnetic print art kits, such as kits 805, magnetic frames, such as magnetic frames 810, or magnetic prints, such as magnetic prints 815. In some embodiments, the magnetic frames 810 are similar to the magnetic frame 100 of FIG. 1. In some embodiments, the magnetic prints 815 are similar to the magnetic print 200 of FIG. 2.

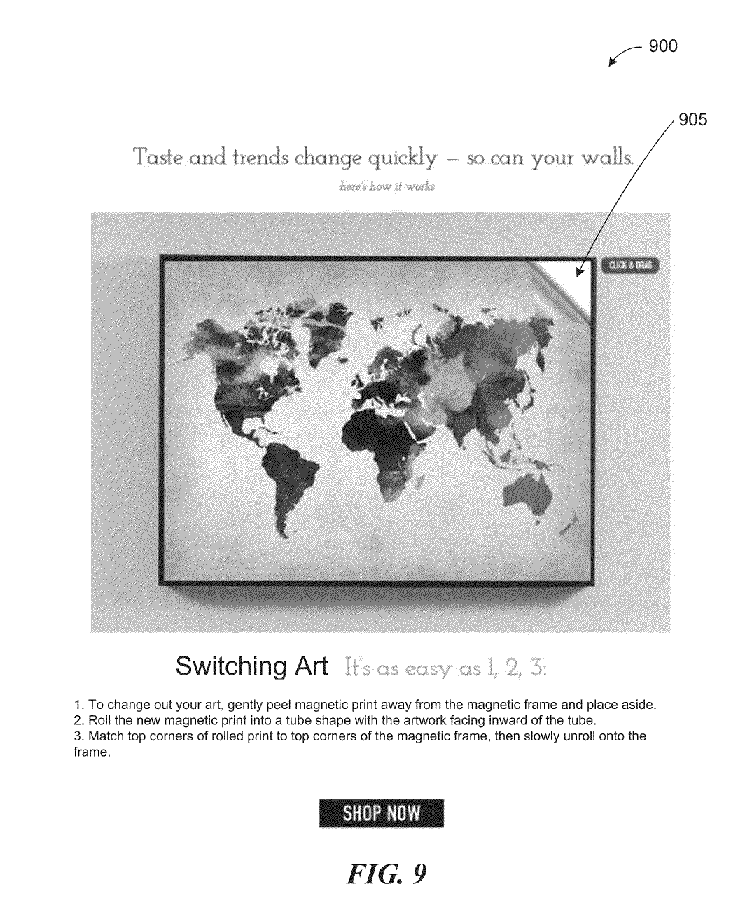

FIG. 9 is an example of a third GUI 900 of the art application 610, consistent with various embodiments. The third GUI 900 allows the user to visualize attaching and/or peeling off the magnetic print, e.g., magnetic print 200, from the magnetic frame, e.g., magnetic frame 100. For example, the user can click and drag 905 the corner of the magnetic print as shown in the third GUI 900 to visualize how the magnetic print can be peeled off from the magnetic frame. The third GUI also displays the instructions for switching an existing magnetic print art to another magnetic print art.

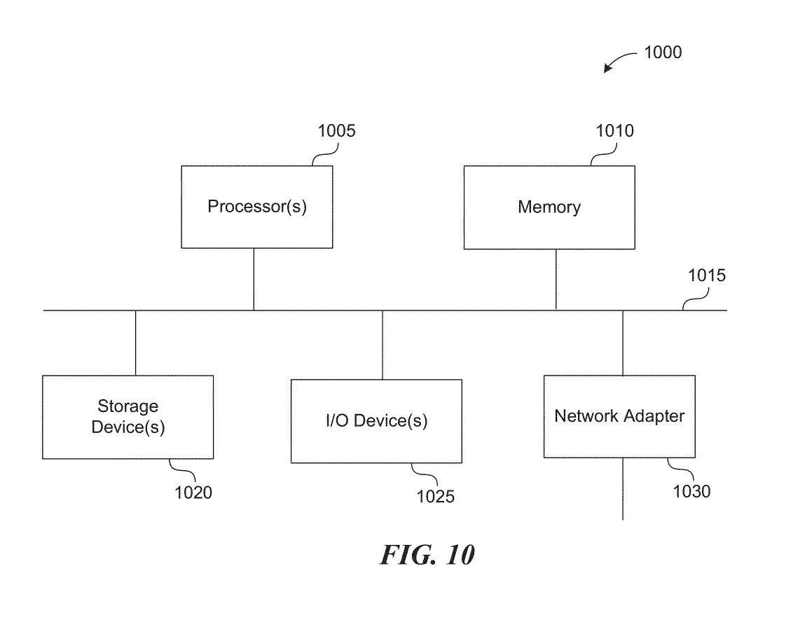

FIG. 10 is a block diagram of an apparatus that may perform various operations, and store various information generated and/or used by such operations, according to an embodiment of the disclosed technique. The apparatus can represent any computer or processing system described herein. The processing system 1000 is a hardware device on which any of the entities, components or services depicted in the examples of the foregoing figures (and any other components described in this specification) can be implemented. The processing system 1000 includes one or more processors 1005 and memory 1010 coupled to an interconnect 1015. The interconnect 1015 is shown in FIG. 10 as an abstraction that represents any one or more separate physical buses, point to point connections, or both connected by appropriate bridges, adapters, or controllers. The interconnect 1015, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 1005 is/are the central processing unit (CPU) of the processing system 1000 and, thus, control the overall operation of the processing system 1000. In certain embodiments, the processor(s) 1005 accomplish this by executing software or firmware stored in memory 1010. The processor(s) 1005 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 1010 is or includes the main memory of the processing system 1000. The memory 1010 represents any form of random access memory (RAM), read-only memory (ROM), flash memory, or the like, or a combination of such devices. In use, the memory 1010 may contain a code. In one embodiment, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 1005 through the interconnect 1015 are a network adapter 1030, a storage device(s) 1020 and I/O device(s) 1025. The network adapter 1030 provides the processing system 1000 with the ability to communicate with remote devices, over a network and may be, for example, an Ethernet adapter or Fibre Channel adapter. The network adapter 1030 may also provide the processing system 1000 with the ability to communicate with other computers within the cluster. In some embodiments, the processing system 1000 may use more than one network adapter to deal with the communications within and outside of the cluster separately.

The I/O device(s) 1025 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 1010 can be implemented as software and/or firmware to program the processor(s) 1005 to carry out actions described above. In certain embodiments, such software or firmware may be initially provided to the processing system 1000 by downloading it from a remote system through the processing system 1000 (e.g., via network adapter 1030).

The techniques introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 1020 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The term “logic”, as used herein, can include, for example, programmable circuitry programmed with specific software and/or firmware, special-purpose hardwired circuitry, or a combination thereof.

Although the present invention has been described with reference to specific exemplary embodiments, it will be recognized that the invention is not limited to the embodiments described, but can be practiced with modification and alteration within the spirit and scope of the embodiments described. Accordingly, the specification and drawings are to be regarded in an illustrative sense rather than a restrictive sense.

References in this description to “an embodiment”, “one embodiment”, or the like, mean that the particular feature, function, or characteristic being described is included in at least one embodiment of the present invention. Occurrences of such phrases in this specification do not necessarily all refer to the same embodiment, nor are they necessarily mutually exclusive.

I/we claim:

1. A magnetic-print art kit comprising:
a frame assembly having a planar surface with magnetic properties, wherein the frame assembly is configured to be mountable on a supporting structure; and
a flexible sheet that is configured to be removably attached to the planar surface, the flexible sheet containing a specified amount of metal, the specified amount selected such that the flexible sheet (a) is flexible enough to be folded into one or more shapes and unfolded to form a flat surface, and (b) remains magnetically attached to the planar surface when installed on the planar surface, wherein the flexible sheet includes an artwork on a first surface of the flexible sheet and attaches removably to the planar surface on a second surface opposite to the first surface.

2. The magnetic-print art kit of claim 1, wherein the flexible sheet is a single layered sheet, and wherein the metal is not a separate layer of the flexible sheet.

3. The magnetic-print art kit of claim 1, wherein the flexible sheet is configured to be rolled into a tube-like shape for packaging and rolled back to a flat surface for installation on the frame assembly.

4. The magnetic-print art kit of claim 1, wherein the flexible sheet is configured to be removed from the frame assembly when peeled off from the frame assembly.

5. The magnetic-print art kit of claim 1, wherein the frame assembly is further configured to facilitate switching of the artwork to another artwork by:
facilitating a user to peel off the flexible sheet from the frame assembly, and
facilitating the user to install another flexible sheet having the another artwork on the frame assembly, by laying out the another flexible sheet on the frame assembly.

6. The magnetic-print art kit of claim 1, wherein the artwork is an image representing the artwork.

7. The magnetic-print art kit of claim 1, wherein the flexible sheet is of the same dimensions as the planar surface of the frame assembly.

8. The magnetic-print art kit of claim 1, wherein the flexible sheet is of a smaller dimension than that of the planar surface of the frame assembly.

9. The magnetic-print art kit of claim 1, wherein the planar surface of the frame assembly has an image of another artwork that is displayed when the flexible sheet is removed from the planar surface.

10. The magnetic-print art kit of claim 1, wherein the frame assembly is configured to host a plurality of flexible sheets simultaneously, the flexible sheets containing different artworks.

11. The magnetic-print art kit of claim 1, wherein the flexible sheet is of a user-defined dimension.

12. The magnetic-print art kit of claim 1 further comprising:
mounting hardware configured to be used for mounting the frame assembly on the supporting structure.

13. A magnetic-print artwork comprising:
a flexible sheet having an artwork printed on a first surface,
wherein the flexible sheet is made using a plurality of materials, the plurality of materials including metal that is attracted to a magnet,
wherein the flexible sheet is configured to be removably installed on a frame assembly having magnetic properties, the flexible sheet configured to be removably installed by laying out the flexible sheet on the frame assembly with a second surface of the flexible sheet in contact with the frame assembly, the second surface being opposite to the first surface, and
wherein the flexible sheet is configured to be removed from the frame assembly by peeling off the flexible sheet from the frame assembly.

14. The magnetic-print artwork of claim 13, wherein the flexible sheet is configured to be reused with another frame assembly, wherein the flexible sheet is configured to be reused by peeling off the flexible sheet from the frame assembly and installing the flexible sheet on the another frame assembly.

15. The magnetic-print artwork of claim 13, wherein the flexible sheet has a set of dimensions that is determined as a function of a set of dimensions of a planar surface of the frame assembly on which the flexible sheet is installed, the planar surface having magnetic properties.

16. The magnetic-print artwork of claim 13, wherein the flexible sheet is configured to be rolled into a tube-like shape for packaging and rolled back to a flat surface for installation on the frame assembly.

17. The magnetic-print artwork of claim 13, wherein the flexible sheet is configured to be installed on any of a plurality of surfaces having magnetic properties.

18. The magnetic-print artwork of claim 13, wherein the flexible sheet is a single layered sheet, and wherein the metal is mixed in the single layered sheet.

19. The magnetic-print artwork of claim 13, wherein the flexible sheet is configured to be installed on the frame assembly without any mounting means other than the flexible sheet itself.

20. A method of switching a magnetic-print artwork on a frame assembly, comprising:
peeling off a first flexible sheet installed on the frame assembly from the frame assembly, the first flexible sheet printed with a first artwork, the first flexible sheet having properties of a metal attracted to a magnet and magnetically attached to the frame assembly, the frame assembly having magnetic properties; and
installing a second flexible sheet printed with a second artwork on the frame assembly, the second flexible sheet having properties of a metal attracted to a magnet, the installing including laying out the second flexible sheet on the frame assembly to magnetically attach the second flexible sheet to the frame assembly, wherein the second flexible sheet is installed on the frame assembly without any mounting means.
